(19) United States
(12) Patent Application Publication
(10) Pub. No.: US 2017/0178172 A1
(43) Pub. Date: Jun. 22, 2017

(54) EVENT TRAFFIC MANAGEMENT SYSTEM

(71) Applicant: International Business Machines Corporation, Armonk, NY (US)

(72) Inventors: Swaminathan Balasubramanian, Troy, MI (US); Thomas G. Lawless, III, Wallkill, NY (US); Jason R. Malinowski, Brentwood, TN (US); Cheranellore Vasudevan, Bastrop, TX (US)

(21) Appl. No.: 14/972,230

(22) Filed: Dec. 17, 2015

(51) Int. Cl. G06Q 30/02; G08G 1/01; G06F 17/50

(52) U.S. Cl. CPC G06Q 30/0231; G06Q 30/0233; G06F 17/5009; G08G 1/0145

(57) ABSTRACT

An aspect of the disclosure includes a method, a system and a computer program product for managing parking and traffic flow at an event. The method includes determining a vehicle exit position for a plurality of vehicles in a parking lot, the plurality of vehicles including a first vehicle. A reward point offer is determined for a first user of the first vehicle to delay an exiting of the first vehicle from the parking lot, the reward point offer being based at least in part on a predictive analytical model. An acceptance of the reward point offer is received from the first user. The vehicle exit position is changed for the first vehicle to a new vehicle exit position. The new vehicle exit position is transmitted to the first user. The exiting of the first vehicle from the parking lot is controlled.

### BACKGROUND

The present invention relates generally to a system and method for managing parking and traffic, and in particular to a system and method of managing parking and traffic at an event or venue having a large population of people.

Events, such as musical concerts or sporting events are typically held in large venues, often in urban areas. In addition to the venue, the surrounding area may include supporting infrastructure, such as parking lots that are sized to accommodate large numbers of people who will be attending the event. Since the people attending the event all attempt to leave about the same time when the event end, traffic flow in areas around venues that may be congested, resulting in long wait time for attendees to leave the area.

### SUMMARY

Embodiments include a method, system, and computer program product for managing parking and traffic flow at an event. The method includes determining a vehicle exit position for a plurality of vehicles in a parking lot, the plurality of vehicles including a first vehicle. A reward point offer is determined for a first user of the first vehicle to delay an exiting of the first vehicle from the parking lot, the reward point offer being based at least in part on a predictive analytical model. An acceptance of the reward point offer is received from the first user. The vehicle exit position is changed for the first vehicle to a new vehicle exit position. The new vehicle exit position is transmitted to the first user. The exiting of the first vehicle from the parking lot is controlled.

Additional features and advantages are realized through the techniques of the present invention. Other embodiments and aspects of the invention are described in detail herein and are considered a part of the claimed invention. For a better understanding of the invention with the advantages and the features, refer to the description and to the drawings.

### BRIEF DESCRIPTION OF THE DRAWINGS

The subject matter which is regarded as the invention is particularly pointed out and distinctly claimed in the claims at the conclusion of the specification. The forgoing and other features, and advantages of the invention are apparent from the following detailed description taken in conjunction with the accompanying drawings in which:

FIG. 1 depicts a cloud computing environment according to an embodiment;

FIG. 2 depicts abstraction model layers according to an embodiment;

FIG. 3 depicts a data flow diagram for a traffic management system for events in according to an embodiment;

FIG. 4 depicts a flow diagram of a method of controlling traffic at an event using reward points; and

FIG. 5 depicts a parking lot controlled by the traffic management system of FIG. 3 according to an embodiment.

### DETAILED DESCRIPTION

Embodiments of the present disclosure provide for a system and method for controlling or managing parking and traffic at an event or venue. Embodiments provide for regulating the timing of vehicles exiting the parking lots at the event to reduce congestion and improve traffic flow.

It is understood in advance that although this disclosure includes a detailed description on cloud computing, implementation of the teachings recited herein are not limited to a cloud computing environment. Rather, embodiments of the present invention are capable of being implemented in conjunction with any other type of computing environment now known or later developed.

Cloud computing is a model of service delivery for enabling convenient, on-demand network access to a shared pool of configurable computing resources (e.g. networks, network bandwidth, servers, processing, memory, storage, applications, virtual machines, and services) that can be rapidly provisioned and released with minimal management effort or interaction with a provider of the service. This cloud model may include at least five characteristics, at least three service models, and at least four deployment models.

Characteristics are as follows:
On-demand self-service: a cloud consumer can unilaterally provision computing capabilities, such as server time and network storage, as needed automatically without requiring human interaction with the service's provider.
Broad network access: capabilities are available over a network and accessed through standard mechanisms that promote use by heterogeneous thin or thick client platforms (e.g., mobile phones, laptops, and PDAs).
Resource pooling: the provider's computing resources are pooled to serve multiple consumers using a multi-tenant model, with different physical and virtual resources dynamically assigned and reassigned according to demand. There is a sense of location independence in that the consumer generally has no control or knowledge over the exact location of the provided resources but may be able to specify location at a higher level of abstraction (e.g., country, state, or datacenter).
Rapid elasticity: capabilities can be rapidly and elastically provisioned, in some cases automatically, to quickly scale out and rapidly released to quickly scale in. To the consumer, the capabilities available for provisioning often appear to be unlimited and can be purchased in any quantity at any time.
Measured service: cloud systems automatically control and optimize resource use by leveraging a metering capability at some level of abstraction appropriate to the type of service (e.g., storage, processing, bandwidth, and active user accounts). Resource usage can be monitored, controlled, and reported providing transparency for both the provider and consumer of the utilized service.

Service Models are as follows:
Software as a Service (SaaS): the capability provided to the consumer is to use the provider's applications running on a cloud infrastructure. The applications are accessible from various client devices through a thin client interface such as a web browser (e.g., web-based e-mail). The consumer does not manage or control the underlying cloud infrastructure including network, servers, operating systems, storage, or even individual application capabilities, with the possible exception of limited user-specific application configuration settings.
Platform as a Service (PaaS): the capability provided to the consumer is to deploy onto the cloud infrastructure consumer-created or acquired applications created using programming languages and tools supported by the provider. The consumer does not manage or control the underlying cloud infrastructure including networks, servers, operating systems, or storage, but has control over the deployed applications and possibly application hosting environment configurations.
Infrastructure as a Service (IaaS): the capability provided to the consumer is to provision processing, storage, networks, and other fundamental computing resources where the consumer is able to deploy and run arbitrary software, which can include operating systems and applications. The consumer does not manage or control the underlying cloud infrastructure but has control over operating systems, storage, deployed applications, and possibly limited control of select networking components (e.g., host firewalls).

Deployment Models are as follows:
Private cloud: the cloud infrastructure is operated solely for an organization. It may be managed by the organization or a third party and may exist on-premises or off-premises.
Community cloud: the cloud infrastructure is shared by several organizations and supports a specific community that has shared concerns (e.g., mission, security requirements, policy, and compliance considerations). It may be managed by the organizations or a third party and may exist on-premises or off-premises.
Public cloud: the cloud infrastructure is made available to the general public or a large industry group and is owned by an organization selling cloud services.
Hybrid cloud: the cloud infrastructure is a composition of two or more clouds (private, community, or public) that remain unique entities but are bound together by standardized or proprietary technology that enables data and application portability (e.g., cloud bursting for load-balancing between clouds).

A cloud computing environment is service oriented with a focus on statelessness, low coupling, modularity, and semantic interoperability. At the heart of cloud computing is an infrastructure comprising a network of interconnected nodes.

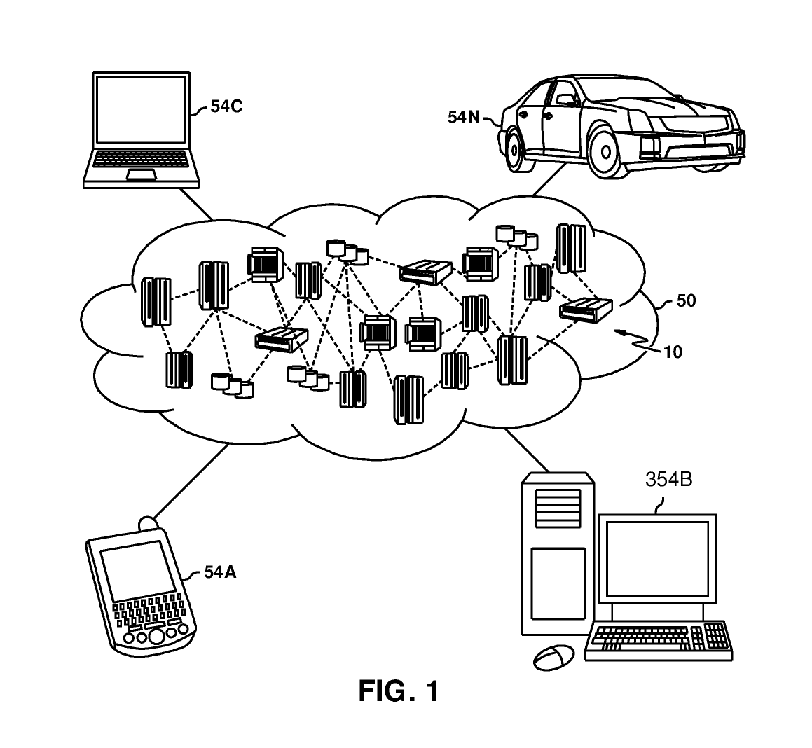

Referring now to FIG. 1, illustrative cloud computing environment 50 is depicted. As shown, cloud computing environment 50 comprises one or more cloud computing nodes 10 with which local computing devices used by cloud consumers, such as, for example, personal digital assistant (PDA) or cellular telephone 54A, desktop computer 54B, laptop computer 54C, and/or automobile computer system 54N may communicate. Nodes 10 may communicate with one another. They may be grouped (not shown) physically or virtually, in one or more networks, such as Private, Community, Public, or Hybrid clouds as described hereinabove, or a combination thereof. This allows cloud computing environment 50 to offer infrastructure, platforms and/or software as services for which a cloud consumer does not need to maintain resources on a local computing device. It is understood that the types of computing devices 54A-N shown in FIG. 1 are intended to be illustrative only and that computing nodes 10 and cloud computing environment 50 can communicate with any type of computerized device over any type of network and/or network addressable connection (e.g., using a web browser).

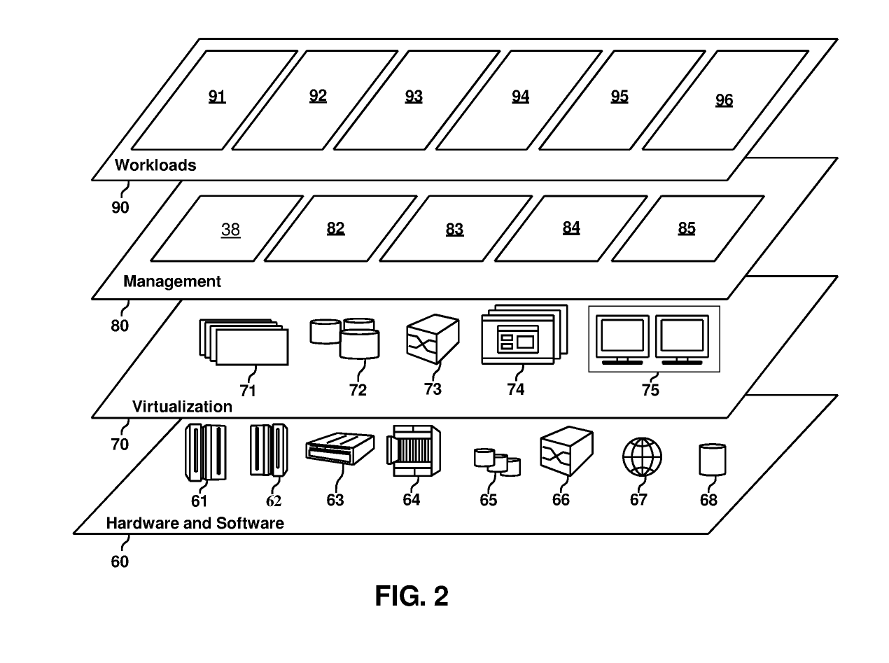

Referring now to FIG. 2, a set of functional abstraction layers provided by cloud computing environment 50 (FIG. 1) is shown. It should be understood in advance that the components, layers, and functions shown in FIG. 2 are intended to be illustrative only and embodiments of the invention are not limited thereto. As depicted, the following layers and corresponding functions are provided:

Hardware and software layer 60 includes hardware and software components. Examples of hardware components include: mainframes 61; RISC (Reduced Instruction Set Computer) architecture based servers 62; servers 63; blade servers 64; storage devices 65; and networks and networking components 66. In some embodiments, software components include network application server software 67 and database software 68.

Virtualization layer 70 provides an abstraction layer from which the following examples of virtual entities may be provided: virtual servers 71; virtual storage 72; virtual networks 73, including virtual private networks; virtual applications and operating systems 74; and virtual clients 75.

In one example, management layer 80 may provide the functions described below. Resource provisioning 81 provides dynamic procurement of computing resources and other resources that are utilized to perform tasks within the cloud computing environment. Metering and Pricing 82 provide cost tracking as resources are utilized within the cloud computing environment, and billing or invoicing for consumption of these resources. In one example, these resources may comprise application software licenses. Security provides identity verification for cloud consumers and tasks, as well as protection for data and other resources. User portal 83 provides access to the cloud computing environment for consumers and system administrators. Service level management 84 provides cloud computing resource allocation and management such that required service levels are met. Service Level Agreement (SLA) planning and fulfillment 85 provides pre-arrangement for, and procurement of, cloud computing resources for which a future requirement is anticipated in accordance with an SLA.

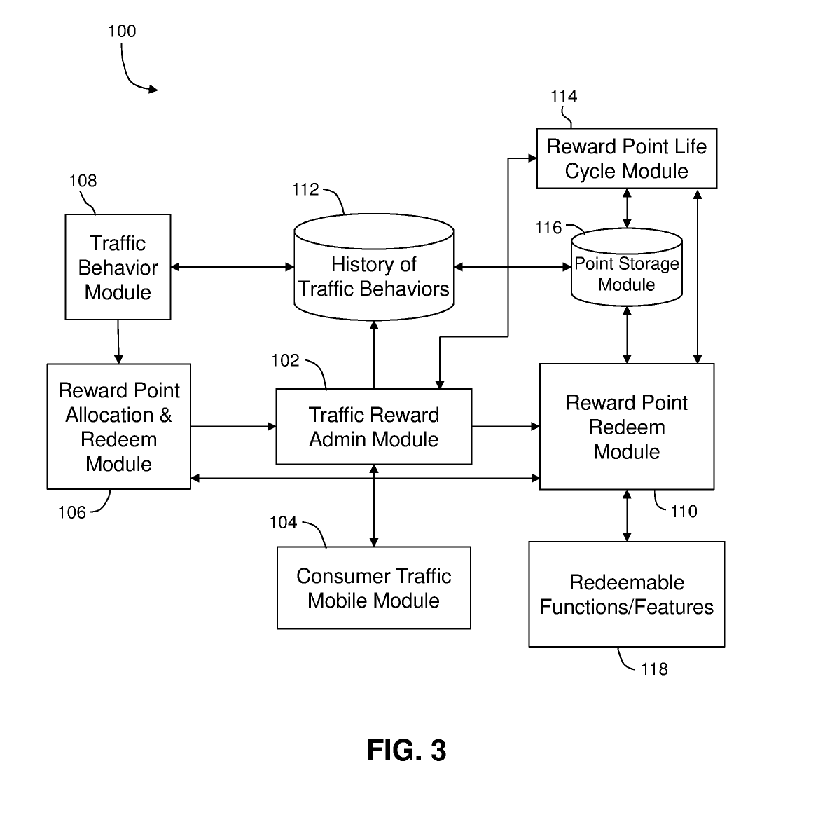

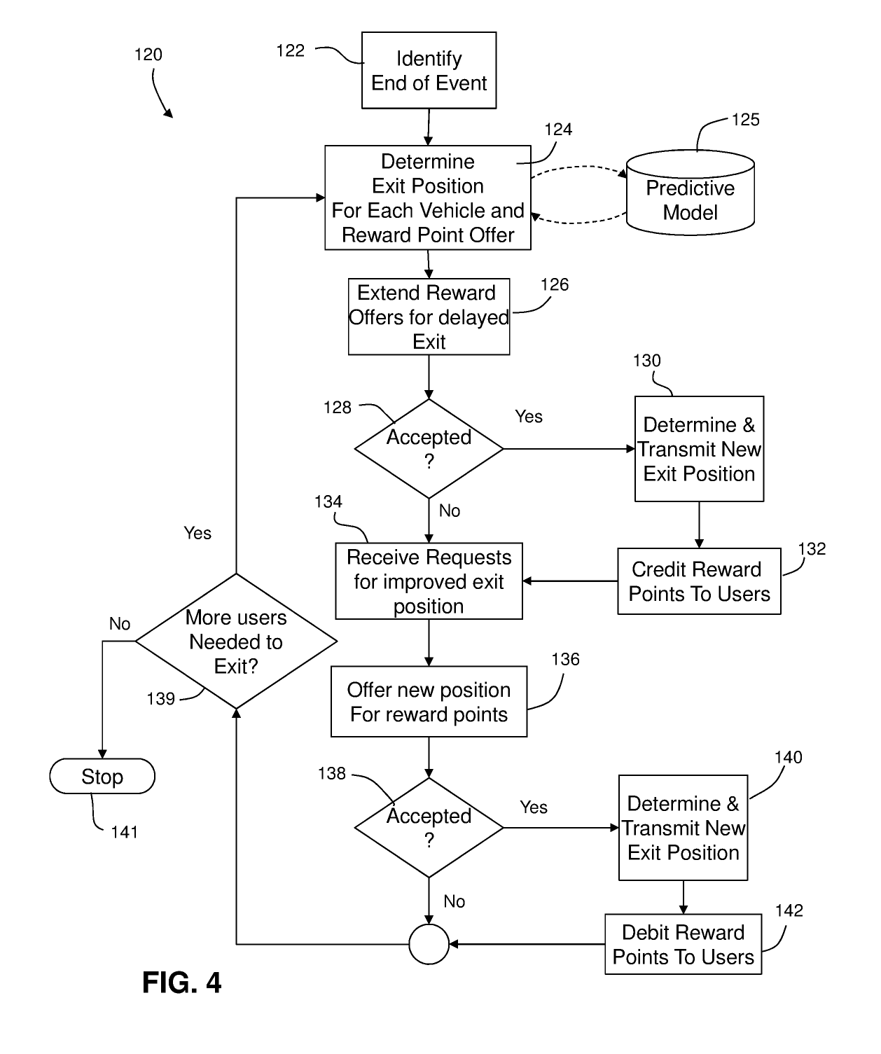

Workloads layer 90 provides examples of functionality for which the cloud computing environment may be utilized. Examples of workloads and functions which may be provided from this layer include: mapping and navigation 91; software development and lifecycle management 92; virtual classroom education delivery 93; data analytics processing 94; transaction processing 95; and a traffic and parking management processing 96. The traffic and parking management processing 96 may perform one or more methods that allow the traffic management system to operate, such as but not limited to the methods described in reference to FIG. 3 and FIG. 4 for example.

Referring now to FIG. 3, an embodiment is shown of a traffic and parking management system 100 for controlling the exiting of vehicles from a parking lot after an event. As used herein, the term “event” means a large gathering of people at a common location where the attendees will leave the location about the same time (e.g. when the event is over). Examples of events include music concerts and sporting events. The system 100 includes a traffic reward module 102 that manages and controls the flow of information to end users that access the system 100 using a mobile module 104. The traffic reward module 102 may be a computing node 10 in the cloud computing environment 50 for example. In an embodiment, the mobile module 104 may be a software application that is executed on a mobile device such as a tablet or cellular phone 54A for example. The mobile module 104 may display information (e.g. accumulated reward points, vehicle exit position, exit time, current offers), receive inputs from the user, and transmit data to the traffic reward module 102.

The traffic reward module 102 receives inputs, such as from the mobile module 104 and an allocation and redeem module 106. The allocation and redeem module 106 manages reward points allotments based on predetermined rules and the availability of reward points to allocate. The allocation and redeem module 106 also determines the price offer (in terms of reward points) extended to users via the traffic reward module 102 and mobile module 104. As will be discussed in more detail herein, the allocation and redeem module 106 determines the price offer based on input from traffic behavior module 108 and a reward point module 110.

The traffic behavior module 108 applies analytical models based on historical data to predict how many users will volunteer to delay their exiting of the parking lot and how many reward points are expected to be utilized. It should be appreciated that by delaying some users from exiting the parking lot, traffic flow in the areas surrounding the event may be more effectively managed and traffic congestion reduced or avoided. In an embodiment, the traffic behavior module 108 may include modules the predict reward point redeeming behavior, such as based on, but not limited to, demographics of people expected to attend the event, time of the event, weather conditions and historical data on volunteering rates at the event location for the type of event being held. In one embodiment, the traffic behavior module 108 may further base reward point behavior based on real-time traffic data (e.g. as congestion increases, reward point offers increase to encourage more volunteers to delay leaving). The reward point module 110 defines rules for the redemption of reward points. The redemption of reward point rules may include early exit position, improved parking location, reduced parking fees, free or reduced event ticket prices, and merchandise or concessions at the event for example. In an embodiment, the redemption of reward points rules may change based at least in part on the type of event that is taking place.

In an embodiment, the amount of reward points offered is determined by an analytical model that is focused on attracting volunteering users while maintaining self-sustaining traffic management system. The analytical model is built using historical records of parking behaviors (e.g. received from historical traffic behavior module 112). Typical factors that are related to particular traffic behaviors include but are not limited to: award point levels at which the users are ready to surrender their exit position, crowd level, time of day and day of week, the location of the user, a user profile, and real-time traffic data. In an embodiment, the user profile may include, but is not limited to: the user's age, marital status, number and age of children, past reward point behavior patterns and past reward point redemption patterns. The analytical model determines a reward point offer that both encourages surrendering of privileges in the right occasions (there should be enough givers and takers for the traffic system to sustain and at the same time to regulate the flow of traffic.

In an embodiment, the analytical model may determine the reward points to offer for a particular situation and user. For example, a family with small children may not surrender a better privilege unless substantial number of reward points are offered. On the other hand, an affluent elderly person may never surrender his/her position. A single adult may be more likely to give up and collect reward points more easily when they are not in a hurry to leave for example.

Similarly, in an embodiment the amount of reward points for getting/buying a privilege (redeeming the reward points) may also be determined by an analytical model that is built from historical data (such as from historical traffic behavior module 112). This analytical model represents the redeemable points that would be deducted from a user's account by certain customers in different situations. For example, a Sunday evening, a family with children in school may want to get home early and may be ready to redeem a large number of his/her accumulated reward points. While a young single passenger on a Saturday midday may not be ready to redeem even a small number points for a more desirable position. The readiness to “buy” a privilege with reward points depends on a particular situation and may be dynamically determined based on the current traffic, time of day, type of user, etc.

The traffic reward module 102 further provides outputs to modules including the reward point module 110, a historical traffic behavior module 112 and a reward point life cycle module 114. The historical traffic behavior module 112 includes a database of traffic and parking behavior data based on previous events that have occurred at this geographic location. The traffic behavior data may include data such as the location of traffic congestion and the times (such as relative to the end of the event, the day of the week and the time of day) that the congestion occurs for example. The parking behavior data may include when parking locations are filled and how quickly people who park in a particular location leave an event for example (e.g. people leave parking lots farther from the event location later than those that part closer). The historical traffic behavior module 112 exchanges data with the traffic behavior module 108 and a point storage module 116. The point storage module 116 is a database that tracks the reward point accounting for all users of the system 100.

The reward point life cycle module 114 includes logic and rules for updating and accumulating reward points by users. For example, when a user agrees to delay their exit from a parking lot in exchange for reward points, the reward point life cycle module 114 includes rules that determine when the reward points are added to the user's account in the point storage module 116. Similarly, when a user utilizes the reward points the reward point life cycle module 114 includes rules that determine when the reward points are deducted from the user's account in point storage module 116. In one embodiment, the reward point life cycle module 114 may include rules that determine how much and when reward points are deducted from a user's account when they don't comply with the exit position instructions when leaving an event. For example, if a user accepts reward points to delay their exit to be the 200^{th} vehicle to leave a parking lot and they actually leave at the 100^{th} vehicle position, the system 100 may deduct additional points from their account to encourage compliance with the operation of system 100. The reward point life cycle module 114 exchanges data with the traffic reward module 102, the point storage module 116 and the reward point module 110. In other embodiments, the system 100 may include logic to detect misuse of the parking arrangement in an effort to improve their vehicle exit position. For example, in an embodiment the system 100 provides the parking offer to only one user per group (e.g. per vehicle) and can determine if offers are extended to multiple persons within the same vehicle.

Finally, the system 100 may include a function and features module 118. The function and features module 118 provides an interface for adding, updating and changing the rules for the redemption of reward points in reward point module 110. The function and features module 118 may include methods for adding non-parking related benefits, such as ticket discounts and concessions for a particular event. In one embodiment, reward points and non-parking related benefits may be extended at any time, such as during the event. For example, if the venue where the event is being held determines during the event that they have an excess quantity of perishable food, discounts on food or food bundles may be offered to users in an attempt to increase the sales of the perishable food. In an embodiment, the discounted (or free) food may be offered in exchange for a later vehicle exit position.

Referring now to FIG. 4, a method 120 is provided for exchanging reward points with users of system 100 in exchange for delayed exit positions or privileges (better parking, discounts, and concessions). The method 120 starts in block 122 with the identification by the system 100 of the end of an event. The method 120 then proceeds to block 124 where the exit position for each vehicle in a parking lot is determined. In an embodiment, the system 100 may also determine exit locations for each vehicle based on traffic flow predictions. The traffic flow predictions may be based at least in part on the number and location of the vehicles attending the event and historical traffic data from historical traffic behavior module 112. In an embodiment, the exit position for a vehicle may be determined when a user returns to their vehicle and activates the mobile module 104. In an embodiment, the determination of the exit position may be based on a predictive model 125 that estimates the position or amount of time to exit based on criteria such as, but not limited to, the position of the vehicle in the parking lot, the acceptance of offers by other users and historical traffic data for example. In an embodiment, the predictive model 125 may also account for the location of the user at the venue relative to other users parked in the same parking lot.

The method 120 then proceeds to block 126 offers are extended to at least some of the users for them delay their exit from the parking lot to control the flow of traffic leaving the event. As discussed herein, the reward point offer may be different for different users depending on the expected traffic flow and the particular profile of the user. The amount of reward points offered may be dynamically determined in the allocation and redeem module 106 based on inputs from the traffic behavior module 108 and the reward point module 110. In one embodiment, the offers may be extended prior to the event ending, allowing users who accept the offer to stay in the event location longer. It should be appreciated that when traffic flow is not an issue and there is no congestion, then no offers to delay may be extended. The method 120 then proceeds to query block 128 where it is determined if the user has accepted the offer.

When query block 128 returns a positive, meaning the user has accepted the offer to delay their exit in exchange for reward points, the method 120 proceeds to block 130 where the new position is determined and transmits the new position to the user. The user's account in point storage module 116 is credited with the appropriate amount of reward points in block 132.

Once the reward points are credited to the user's account, or if the query block 128 returns a negative (offer not accepted), then the method 120 proceeds to block 134, where requests to improve a user's vehicle exit position are received. The method 120 determines the availability of improving the requestor's exit position. For example, if no one volunteers to delay their exit, there may be no exit slots available to improve the user's exit position. In one embodiment, the method 120 extends offers to user's in the queue ahead of the requestor to entice them to volunteer and delay their exit. In an embodiment, demands may be received and offers extended in parallel with each other. In an embodiment, the determination of the number of offers to extend may be based on historical data of the average number of users who accept and the levels of delay and points they are willing to accept.

The method 120 then proceeds to block 136 where an offer of a new position and the amount of reward points the user will have to redeem are transmitted to the requestor. In an embodiment, the determination of the amount of points to be redeemed is dynamically determined based on a user profile and the current context at that moment in time. In an embodiment, the current context may include, but is not limited to, where the user is relative to the parking lot (e.g. in the vehicle versus still in the venue), the traffic in the area around the parking lot and in the greater area around the venue, how many users are currently or simultaneously waiting to exit from the parking lot, how many users are currently waiting to start the exit process, the location of the vehicle in the parking lot, the weather and historical data on offer acceptance and levels. In an embodiment, the offer may be based on the current context, historical traffic data and the time of day when the event ends. In an embodiment, the user profile may include, but is not limited to: the user's age, marital status, number and age of children, past reward point behavior patterns and past reward point redemption patterns. In query block 138 it is determined if the offer is accepted by the user. If the user accepts, the method 120 proceeds to block 140 where the user's vehicle exit position is changed and transmitted to the requestor. The method 120 then proceeds to block 142 where the amount of reward points in the offer are debited from the user's account.

After debiting the user's account, or when the user declines the offer, the method 120 proceeds to query block 139 where it is determined if more users are needed to delay their vehicle exit in order to obtain a desired traffic flow. When query block 139 returns a positive (e.g. more delay is needed), the method 120 loops back to block 124 where additional offers may be made to delay exit for improving traffic flow. When query block 139 returns a negative (e.g. no additional vehicle delay is needed), the method 120 proceeds to block 141 and the process stops. It should be appreciated that while the method 120 is illustrated as a linear set of steps, this is for exemplary purposes and the method 120 may be performed in another order and some of the steps may be performed simultaneously (e.g. the method may extend offers to delay while simultaneously receiving requests for privileges).

In an embodiment, the exit from the parking lot is controlled by the system 100. The control may be performed by a physical gate that only allows one vehicle to leave at a time for example. The gate may be controlled by a reader, such as an RFID or optical reader for example, that verifies the vehicle exiting the parking lot. In this embodiment, the user may have an identification means, such as a ticket, an RFID transponder, or a keycard for example. In one embodiment, the identification means is the user's mobile device that includes the mobile module 104. In an embodiment, the mobile module displays an exit “ticket” in the form of a vehicle exit position number and a machine readable code (e.g. a bar code or QR code). When exiting, the user holds their mobile device up to an optical reader and the system 100 records the actual exit position of the vehicle and opens the gate.

In an embodiment, when the actual exit position is recorded, the system 100 compares the actual exit position to the assigned exit position. When the actual exit position deviates from the assigned exit position by a predetermined threshold, the system 100 may deduct points from the user's account to encourage compliance with the exit order.

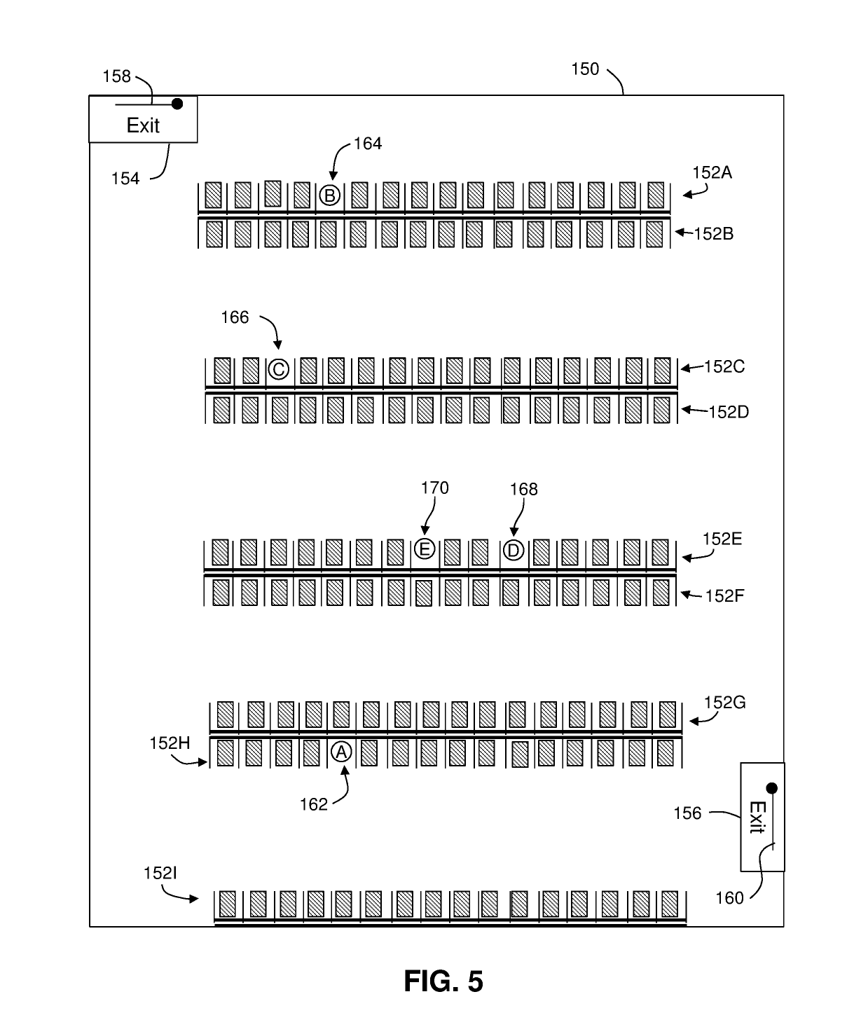

Turning now to FIG. 5, use case scenarios will be described for the operation of system 100 in accordance with some embodiments. A parking lot 150 is illustrated in FIG. 5 having a plurality of parking spots for users to park their vehicle while they attend an event. Generally, the parking spots are arranged in rows 152A-1521 with spaces therebetween to allow vehicles to enter and exit. There are a limited number of exits 154, 156 to allow vehicles to exit the parking lot 150. The exits 154, 156 may include computer controlled gates 158, 160 that regulate the exiting of vehicles from the parking lot 150.

In a first use case scenario, a user “A” in parking location 162 has a parking spot that enables him to have a vehicle exit position 20, meaning there are 19 vehicles ahead of him. User A has a high level or premium parking spot that allows him to exit early. User A executes the mobile module 104 and receives an offer of 10,000 reward points from system 100 if he waits an additional 10 minutes to exit after first 200 vehicles. Since User A is not in a hurry on that day, he accepts the offer and waits for his turn to exit have left. The mobile module 104 displays his new time and position to exit and also reports his accumulated reward points.

In a second use case scenario, a user “B” in parking location 164 has a parking location that enables her to exit the parking lot 150 after just 10 cars. Due to her location the system 100 predicts that she can exit the parking lot 150 within 2 minutes. User B logs into the mobile module 104 and receives an offer of 1,500 reward points if she waits for 5 minutes to exit after 100 vehicles. However, User B needs to reach airport to pick someone up and subsequently rejects the offer. User B continues to use her original turn to exit and neither earns or loses any reward points.

In a third use case scenario, a user “C” in location 166 got a parking spot which is 50 cars behind the first vehicle to exit. User C logs into the mobile module 104 to find her turn to exit. She receives an offer from system 100 of 1,000 points to exit after 200 cars. Although User C is not in a hurry, she doesn't find 1,000 points attractive enough to wait for 10 minutes and rejects the offer.

In a fourth use case scenario, a user “D” in location 168 got a parking spot that will allow User D to exit after 200 vehicles have left the parking lot 150. He logs into the mobile module 104 and requests an improved exit position. In an embodiment, the system 100 may provide User D with alternative offers. A first offer would be to receive an improved exit position of the 100^{th} vehicle in exchange for 10,000 reward points. The second offer would be to park in a different parking lot (such as one that is less full or better positioned for traffic flow) and exit as the 20^{th} vehicle in exchange for 15,000 reward points. Since User D has a balance of 70,000 reward points accumulated so far. User D accepts the second offer for parking in the other parking lot.

In a fifth use case scenario, a user “E” in location 170 is located in a parking spot that will allow exit after 200 vehicles have left the parking lot 150. User E has an urgent need to leave after the event. Logging into the mobile module 104 and checks whether he can get an improved vehicle exit position. User E has 30,000 points accumulated. User E gets an offer from system 100 to redeem 20,000 points in order to exit after 20 cars. User E rejects the offer and receives a subsequent or second offer to redeem 7,000 points to exit after 100 cars with a predicted time savings of about 5 minutes. User E accepts this offer and redeems 7,000 points.

It should be appreciated that while embodiments herein describe the interactions of the users with the system 100 prior to the event, this is for exemplary purposes and the claimed invention should not be so limited. In other embodiments, the users may interact with the system 100 prior to the event, such as to arrange parking in a particular parking lot or parking space for example. In other embodiments, the users may interact with the system 100 during the event to change their vehicle parking position, to exchange reward points, or to obtain concessions or merchandise from the event.

Technical effects and benefits of some embodiments include providing a system for improving traffic flow from vehicles exiting parking lots after an event.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of all means or step plus function elements in the claims below are intended to include any structure, material, or act for performing the function in combination with other claimed elements as specifically claimed. The description of the present invention has been presented for purposes of illustration and description, but is not intended to be exhaustive or limited to the invention in the form disclosed. Many modifications and variations will be apparent to those of ordinary skill in the art without departing from the scope and spirit of the invention. The embodiments were chosen and described in order to best explain the principles of the invention and the practical application, and to enable others of ordinary skill in the art to understand the invention for various embodiments with various modifications as are suited to the particular use contemplated.

The present invention may be a system, a method, and/or a computer program product. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Java, Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

What is claimed is:

1. A computer-implemented method comprising:
determining by a processing device, a vehicle exit position for a plurality of vehicles in a parking lot, the plurality of vehicles including a first vehicle;
determining by a processing device, a reward point offer for a first user of the first vehicle to delay an exiting of the first vehicle from the parking lot, the reward point offer being based at least in part on a predictive analytical model;
receiving by a processing device, an acceptance of the reward point offer from the first user;
changing by a processing device, the vehicle exit position for the first vehicle to a new vehicle exit position;
transmitting by a processing device, the new vehicle exit position to the first user; and
controlling by a processing device, the exiting of the first vehicle from the parking lot.

2. The method of claim 1, wherein the predictive analytic model is based at least in part on a current context, a user profile and a model based on a history of traffic behaviors.

3. The method of claim 1, further comprising crediting a user account associated with the first user in an amount of the reward point offer based on receiving the acceptance.

4. The method of claim 3, further comprising: transmitting a machine readable code to a mobile module associated with the first user, wherein the controlling the exiting includes reading the machine readable code and opening a gate based on the machine readable code.

5. The method of claim 1, wherein the historical traffic data further includes historical data on how many people volunteer to delay exiting at different reward point thresholds, and determining the reward point offer further includes real-time traffic data for a parking lot location.

6. The method of claim 1, further comprising: receiving a request to redeem reward points from a second user and determining a redeeming offer to lower a second vehicle exit position of a second vehicle associated with the second user.

7. The method of claim 6, wherein the redeeming offer being based at least in part on a user profile for the second user.

8. The method of claim 6, further comprising:
receiving an acceptance of the redeeming offer;
changing the second vehicle exit position for the second vehicle to a third vehicle exit position;
transmitting the third vehicle exit position to the second user; and
controlling the exiting of the second vehicle from the parking lot.

9. The method of claim 1, further comprising storing the reward point offer accepted by the first user.

10. A system, comprising:
a memory having computer readable instructions; and
one or more processors for executing the computer readable instructions, the computer readable instructions comprising:
determining a vehicle exit position for a plurality of vehicles in a parking lot, the plurality of vehicles including a first vehicle;
determining a reward point offer for a first user of the first vehicle to delay an exiting of the first vehicle from the parking lot, the reward point offer being based at least in part on a predictive analytic model;
receiving an acceptance of the reward point offer from the first user;
changing the vehicle exit position for the first vehicle to a new vehicle exit position;
transmitting the new vehicle exit position to the first user; and
controlling the exiting of the first vehicle from the parking lot.

11. The system of claim 10, wherein the predictive analytic model is based at least in part on a current context, a user profile and a model based on a history of traffic behaviors.

12. The system of claim 10, wherein the computer readable instructions further comprise crediting a user account associated with the first user in an amount of the reward point offer based on receiving the acceptance.

13. The system of claim 12, wherein the computer readable instructions further comprise: transmitting a machine readable code to a mobile module associated with the first user, wherein the controlling the exiting includes reading the machine readable code and opening a gate based on the machine readable code.

14. The system of claim 10, wherein the historical traffic data further includes historical data on how many people volunteer to delay exiting at different reward point thresholds, and the determining the reward point offer further includes real-time traffic data for a parking lot location.

15. The system of claim 10, wherein the computer readable instructions further comprise: receiving a request to redeem reward points from a second user and determining a redeeming offer to lower a second vehicle exit position of a second vehicle associated with the second user.

16. The system of claim 15, wherein the computer readable instructions further comprise:
receiving an acceptance of the redeeming offer;
changing the second vehicle exit position for the second vehicle to a third vehicle exit position;
transmitting the third vehicle exit position to the second user; and
controlling the exiting of the second vehicle from the parking lot.

17. A computer program product for managing parking and traffic flow at an event, the computer program product comprising a computer readable storage medium having program instructions embodied therewith, the program instructions executable by a processor to cause the processor to perform:
determining a vehicle exit position for a plurality of vehicles in a parking lot, the plurality of vehicles including a first vehicle;
determining a reward point offer for a first user of the first vehicle to delay an exiting of the first vehicle from the parking lot, the reward point offer being based at least in part on a predictive analytic model;
receiving an acceptance of the reward point offer from the first user;
changing the vehicle exit position for the first vehicle to a new vehicle exit position;
transmitting the new vehicle exit position to the first user; and
controlling the exiting of the first vehicle from the parking lot.

18. The computer program product of claim 17, wherein the predictive analytic model is based at least in part on a current context, a user profile and a model based on a history of traffic behaviors.

19. The computer program product of claim 17, wherein the processor further performs:
crediting a user account associated with the first user in an amount of the reward point offer based on receiving the acceptance;
transmitting a machine readable code to a mobile module associated with the first user, wherein the controlling the exiting includes reading the machine readable code and opening a gate based on the machine readable code; and
wherein the historical traffic data further includes historical data on how many people volunteer to delay exiting at different reward point thresholds, and the determining the reward point offer further includes real-time traffic data for a parking lot location.

20. The computer program product of claim 17, wherein the processor further performs:
receiving a request to redeem reward points from a second user and determining a redeeming offer to lower a second vehicle exit position of a second vehicle associated with the second user;
receiving an acceptance of the redeeming offer;
changing the second vehicle exit position for the second vehicle to a third vehicle exit position;
transmitting the third vehicle exit position to the second user; and
controlling the exiting of the second vehicle from the parking lot.
